(19) United States
(12) Patent Application Publication
(10) Pub. No.: US 2026/0175906 A1
(43) Pub. Date: Jun. 25, 2026

(54) STEERING ACTUATOR AND MOBILITY DEVICE COMPRISING SAME

(71) Applicant: HL MANDO CORPORATION, Gyeonggi-do (KR)

(72) Inventor: Jeong Hwa HAN, Gyeonggi-do (KR)

(21) Appl. No.: 19/124,826

(22) PCT Filed: Mar. 5, 2024
(86) PCT No.: PCT/KR2024/002816

§ 371 Date: Apr. 25, 2025

(30) Foreign Application Priority Data
Aug. 21, 2023 (KR) 10-2023-0109324

(51) Int. Cl. B62D 5/04; B62D 15/02

(52) U.S. Cl. CPC B62D 5/0463; B62D 5/0403; B62D 5/0409; B62D 5/0421; B62D 5/049; B62D 15/021; B62D 15/0215

(57) ABSTRACT

According to the present embodiments, provided is a steering actuator comprising a motor, an output shaft connected to a knuckle arm, and a reducer connecting the motor and the output shaft. In addition, according to the present embodiments, provided is a mobility device comprising a steering actuator which comprises a motor, an output shaft connected to a knuckle arm, and a reducer connecting the motor and the output shaft. According to the present embodiments, the steering actuator having a compact structure and capable of improving steering feeling of a driver and the mobility device comprising the steering actuator can be provided.

### TECHNICAL FIELD

The present embodiments relate to a steering actuator and a mobility vehicle including the same.

### BACKGROUND ART

Recently, interest in small mobility vehicles has been increasing. Small mobility vehicles may be used as urban mobility vehicles suitable for a small number of passengers and short distance travel. These small mobility vehicles are designed with a lightweight body and a high center of gravity. To compensate for the reduced driving stability caused by the lightweight body and high center of gravity and to provide drivers with dynamic driving, small mobility vehicles may be equipped with the lean function that tilts the body depending on the driving direction.

The small mobility vehicle includes a steering input device for the driver to input steering wheel manipulation, a steering actuator for generating a steering force for steering the wheels according to the steering wheel manipulation, and a lean actuator for performing the lean function.

Given their small body and uses, small mobility vehicles require that various devices equipped therein be small in size.

### DETAILED DESCRIPTION OF THE INVENTION

### Technical Problem

Conceived in the foregoing background, the present embodiments relate to a steering actuator having a compact structure and capable of enhancing the driver's sense of steering and a mobility vehicle including the same.

### Technical Solution

According to the present embodiments, there may be provided a steering actuator comprising a motor, an output shaft connected to a knuckle arm, and a reducer connecting the motor and the output shaft.

According to the present embodiments, there may be also provided a mobility vehicle comprising a steering actuator including a motor, an output shaft connected to a knuckle arm, and a reducer connecting the motor and the output shaft.

### Advantageous Effects

According to the present embodiments, there may be provided a steering actuator having a compact structure and capable of enhancing the driver's sense of steering and a mobility vehicle including the same.

### BRIEF DESCRIPTION OF DRAWINGS

The above and other objects, features, and advantages of the disclosure will be more clearly understood from the following detailed description, taken in conjunction with the accompanying drawings, in which:

FIG. 1 is a perspective view illustrating a steering actuator according to the present embodiments;

FIG. 2 is a perspective view illustrating a steering actuator and a Pitman arm according to the present embodiments;

FIG. 3 is an exploded perspective view illustrating a portion of a steering actuator according to the present embodiments;

FIG. 4 is a cross-sectional view illustrating a steering actuator according to the present embodiments;

FIG. 5 is an exploded perspective view illustrating a portion of a steering actuator according to the present embodiments;

FIG. 6 is a cross-sectional view illustrating a steering actuator according to the present embodiments;

FIG. 7 is an exploded perspective view illustrating a steering actuator according to the present embodiments;

FIG. 8 is a bottom view illustrating a portion of a steering actuator according to the present embodiments;

FIG. 9 is a plan view illustrating a portion of a steering actuator according to the present embodiments; and

FIGS. 10A, 10B, and 10C are views illustrating a mobility vehicle according to the present embodiments.

### MODE FOR CARRYING OUT THE INVENTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

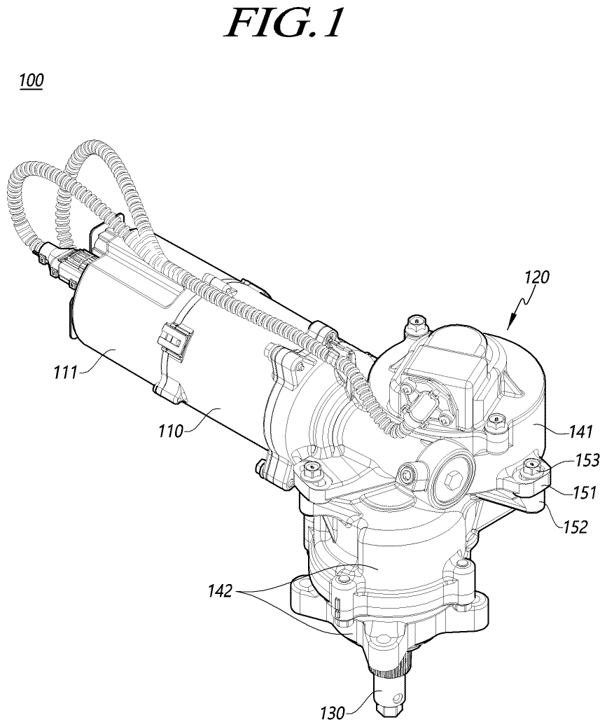

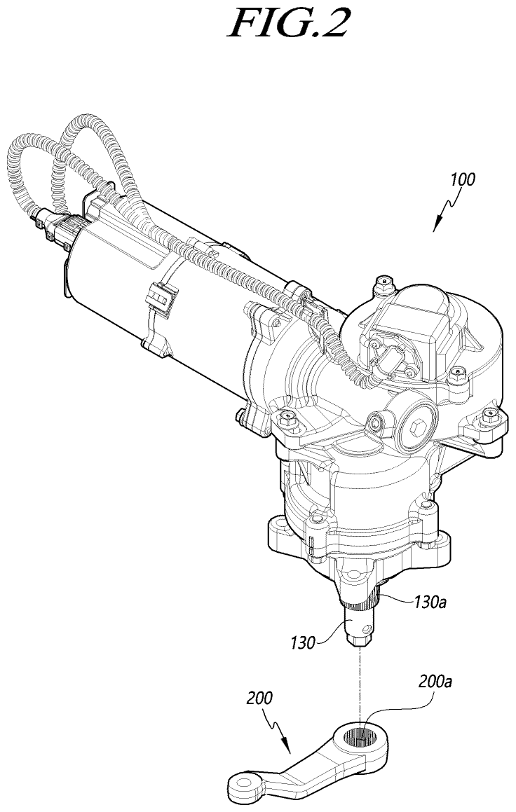

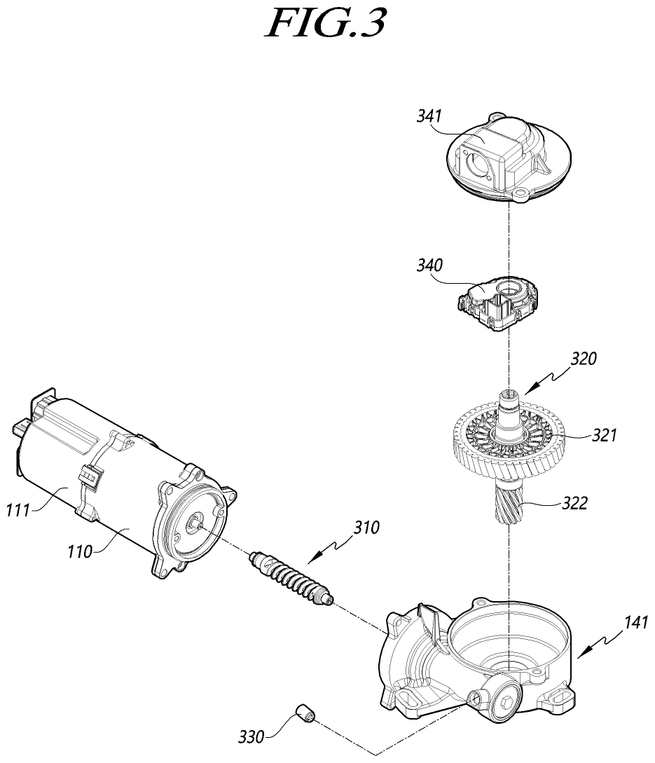

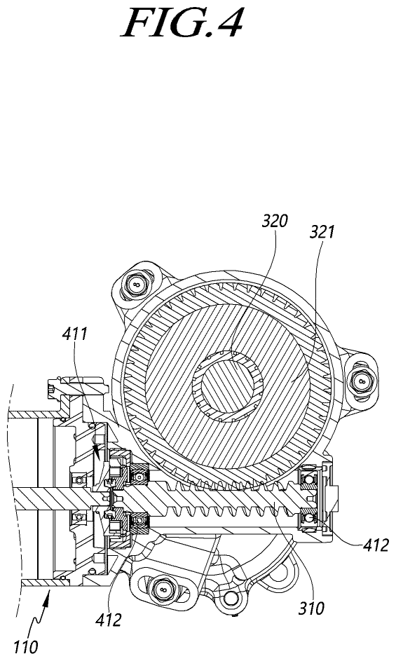

FIG. 1 is a perspective view illustrating a steering actuator according to the present embodiments. FIG. 2 is a perspective view illustrating a steering actuator and a Pitman arm according to the present embodiments. FIG. 3 is an exploded perspective view illustrating a portion of a steering actuator according to the present embodiments. FIG. 4 is a cross-sectional view illustrating a steering actuator according to the present embodiments.

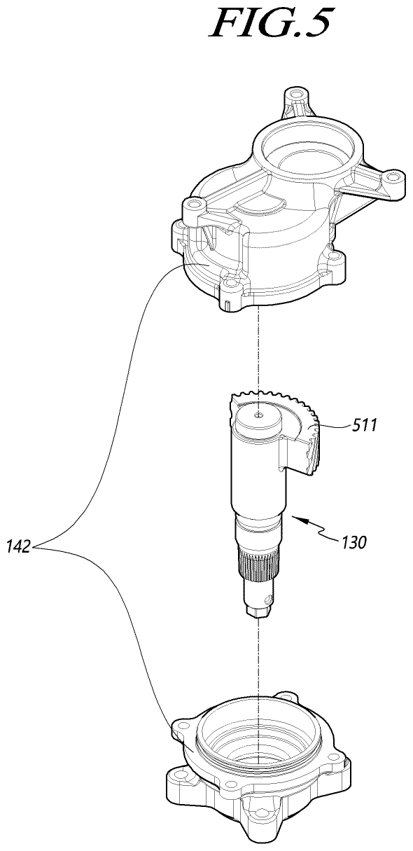

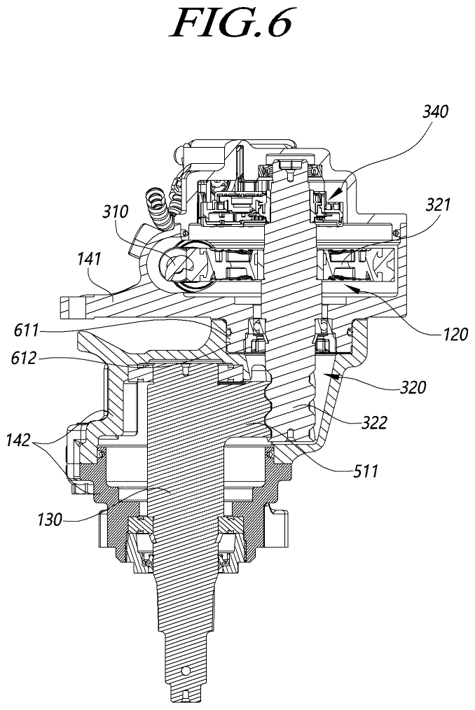

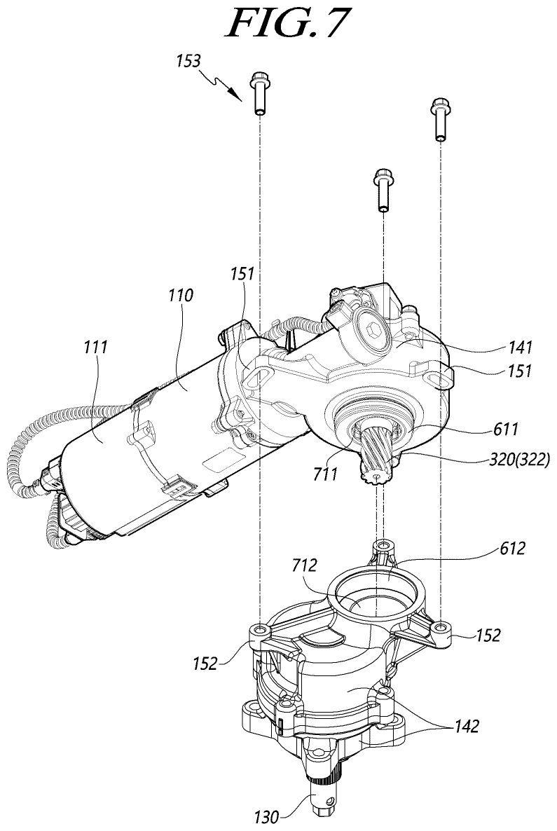

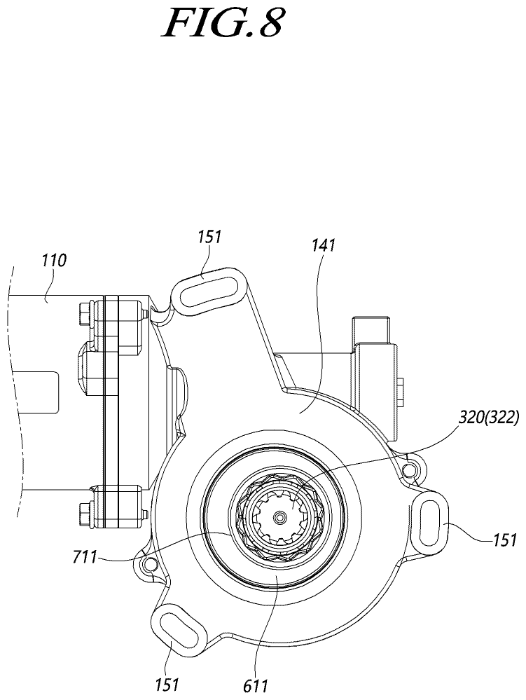

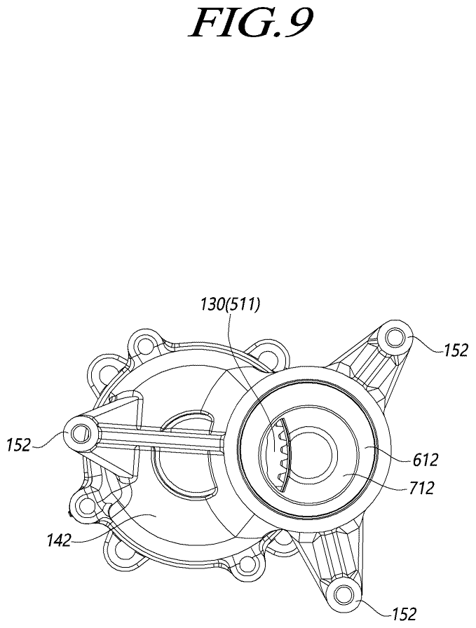

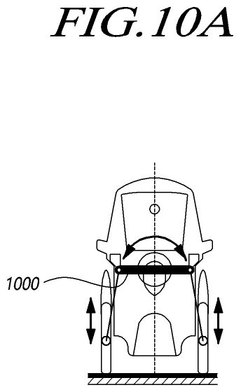

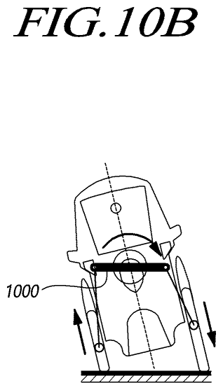

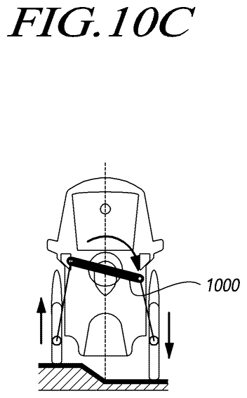

FIG. 5 is an exploded perspective view illustrating a portion of a steering actuator according to the present embodiments. FIG. 6 is a cross-sectional view illustrating a steering actuator according to the present embodiments. FIG. 7 is an exploded perspective view illustrating a steering actuator according to the present embodiments. FIG. 8 is a bottom view illustrating a portion of a steering actuator according to the present embodiments. FIG. 9 is a plan view illustrating a portion of a steering actuator according to the present embodiments. FIGS. 10A, 10B, and 10C are views illustrating a mobility vehicle according to the present embodiments.

According to the present embodiments, there may be provided a steering actuator 100 including a motor 110, an output shaft 130, and a reducer 120 connecting the motor 110 and the output shaft 130.

According to the present embodiments, there may also be provided a mobility vehicle including the steering actuator 100.

The lean function of the mobility vehicle according to the present embodiments is described with reference to FIGS. 10A to 10C.

FIG. 10A illustrates a state in which the lean function of the mobility vehicle according to the present embodiments is not performed, e.g., stop, advance, or reverse state. FIGS. 10B and 10C illustrate states in which the lean function of the mobility vehicle according to the present embodiments is performed. FIG. 10B illustrates a state in which the vehicle body is tilted by the lean function while turning, and FIG. 10C illustrates a state in which the heights of the left and right wheels are offset by the lean function in a stepped area.

In other words, the use of the lean function may enhance driving stability while turning and provide a dynamic driving environment to the user while providing suspension against the stepped ground surface.

The mobility vehicle according to the present embodiments includes a lean bar 1000 of which two opposite ends are connected to the left and right wheels to perform the lean function.

The two opposite ends of the lean bar 1000 are connected to the left and right wheels through a linkage structure. The mobility vehicle according to the present embodiments includes a lean actuator which rotates the lean bar to perform the lean function.

The mobility vehicle according to the present embodiments includes a steering actuator 100 according to the present embodiments. The steering actuator 100 according to the present embodiments is provided in a mobility vehicle according to the present embodiments and generates a steering force for steering the wheels.

According to an embodiment, the mobility vehicle according to the present embodiments may further include a steering angle sensor for sensing the rotational angle of the steering shaft and an electronic control unit receiving rotational angle information about the steering shaft from the steering angle sensor to control the steering actuator 100.

The mobility vehicle according to the present embodiments may further include a steering input device receiving the driver's steering wheel manipulation. The steering shaft of the steering input device may be connected to the steering wheel, and the driver may operate the steering input device through steering wheel manipulation.

The steering angle sensor senses the rotational angle of the steering shaft and transmits the rotational angle to the electronic control unit. The electronic control unit may control the steering actuator based on the rotational angle information about the steering shaft received from the steering angle sensor and other information, e.g., the vehicle velocity and the driver's steering torque.

Under the control of the electronic control unit, the steering actuator generates a steering force for steering the wheels, and steering of the mobility vehicle according to the present embodiments is performed.

According to an embodiment, the steering actuator 100 according to the present embodiments may steer the front wheels of the mobility vehicle according to the present embodiments. The two front wheels of the mobility vehicle according to the present embodiments may be connected to the lean bar, and the lean function may be performed by the lean actuator, and they may be steered by the steering actuator.

Referring to FIG. 1, a steering actuator 100 according to the present embodiments includes a motor 110, an output shaft 130, and a reducer 120. The motor 110 is connected to the output shaft 130 by the reducer 120, and the power of the motor 110 is reduced by the reducer 120 and rotates the output shaft 130. The output shaft 130 is connected to the knuckle arm (not shown) directly or indirectly, e.g., via a linkage structure, and the wheels of the vehicle are steered by rotation of the output shaft 130.

As described below in detail, the first housing 141 receives the reducer 120 and is coupled to the motor 110, and the second housing 142 receives the output shaft 130 and is coupled to the first housing 141.

The second housing 142 includes a lower housing and an upper housing, and the lower housing and the upper housing may be coupled to each other while receiving the output shaft 130 therebetween. The first housing 141 has a first coupling portion 151, and the second housing 142 has a second coupling portion 152, and they are coupled by a coupling member 153.

Referring to FIG. 2, according to an embodiment, the output shaft 130 may be coupled with a Pitman arm 200 connected to the knuckle arm. The Pitman arm 200 is coupled to the output shaft 130 to rotate along with the output shaft 130. The Pitman arm 200 may be connected to the knuckle arm directly or indirectly, e.g., via a linkage structure.

According to an embodiment, at least one of the output shaft 130 and the Pitman arm 200 may be serrated to be coupled. As shown in FIG. 2, an end portion of the output shaft 130 may be provided to protrude from the housing. Serrations 130a coupled to the Pitman arm 200 may be formed in the protruding end portion of the output shaft 130, and serrations 200a may be formed inside the coupling hole of the Pitman arm 200.

Referring back to FIG. 1, according to an embodiment, the steering actuator 100 according to the present embodiments may further include an electronic control unit 111 for controlling the motor 110.

The electronic control unit 111 may receive information sensed by various sensors equipped in the mobility vehicle, e.g., the driver's steering wheel steering angle, steering torque, and lean bar rotational angle information, and control the rotation direction and speed of the motor 110.

Referring to FIG. 3, according to an embodiment, the steering actuator 100 according to the present embodiments may include a rotational angle sensor 340 for sensing the rotational angle of the output shaft 130.

A sensor cover 341 for receiving the rotational angle sensor 340 may be coupled to the first housing 141. The rotational angle sensor 340 may sense the rotational angle of the output shaft 130, and the sensed rotational angle information may be transmitted to the electronic control unit 111 for controlling the rotation direction and speed of the motor 110.

The electronic control unit 111 may control the motor 110 based on the rotational angle information about the output shaft 130 and other information. As shown in the drawings, the rotational angle sensor 340 may indirectly sense the rotational angle of the output shaft 130 from the rotational angle of the second shaft 320.

A structure in which the power of the motor 110 is reduced and transferred to the output shaft 130 is described below with reference to FIGS. 3 to 6.

According to an embodiment, the reducer 120 may include a first shaft 310 coupled to the motor shaft of the motor 110 and a second shaft 320 having a reduction ratio and rotated by rotation of the first shaft 310.

The first shaft 310 may be provided coaxially with the motor shaft of the motor 110 to be rotated along with the motor shaft. The second shaft 320 may be rotated with a reduction ratio with respect to the first shaft 310.

The reduction ratio of the second shaft 320 to the first shaft 310 may be smaller than 1, so that the power of the motor 110 may be primarily reduced while being transferred from the first shaft 310 to the second shaft 320.

According to an embodiment, the first shaft 310 may be a worm shaft, and the second shaft 320 may have a worm wheel 321 engaged with the worm shaft. The first shaft 310 and the second shaft 320 are disposed perpendicular to each other, and the worm gear of the worm shaft and the worm wheel 321 are engaged with each other, and the power of the motor 110 is reduced.

One end portion of the worm shaft may be coupled with the motor shaft of the motor 110 by, e.g., a damping coupler 411. Further, a bearing 412 may be coupled to the first housing 141 to support two opposite ends of the first shaft 310.

According to an embodiment, there may be provided a pressurizing member 330 that pressurizes the first shaft 310 in a direction of being engaged with the worm wheel 321.

The pressurizing member 330 pressurizes the other end portion of the first shaft 310 to provide a pressurizing force to the first shaft 310 in the direction of being engaged with the worm wheel 321. Noise generated when the first shaft 310 and the second shaft 320 are driven is reduced by the pressurizing force provided by the pressurizing member 330.

The first housing 141 may have a coupling hole where the pressurizing member 330 is inserted, so that the pressurizing member 330 may pressurize the other end portion of the first shaft 310 in the coupling hole of the first housing 141. The pressurizing member 330 may include a supporting member supported on the other end portion of the first shaft 310, a coupling member coupled to the first housing 141, and an elastic member provided between the coupling member and the supporting member.

According to an embodiment, the second shaft 320 may have a first gear portion 322, and the output shaft 130 may have a second gear portion 511 engaged with the first gear portion 322.

According to an embodiment, the reduction ratio of the output shaft 130 to the second shaft 320 may be smaller than 1. In other words, the power of the motor 110 is transferred from the first shaft 310 to the second shaft 320 while being primarily reduced, and is then transferred from the second shaft 320 to the output shaft 130 while being secondarily reduced. Therefore, it is possible to obtain a high reduction ratio with a compact structure.

According to an embodiment, the first gear portion 322 may be a pinion gear, and the second gear portion 511 may be a sector gear. The second shaft 320 and the output shaft 130 may be disposed parallel to each other, and in their axially overlapping portions, the first gear portion 322 and the second gear portion 511, respectively, may be formed and engaged with each other.

Meanwhile, as the power of the motor 110 is transferred in the order of the first shaft 310, the second shaft 320, and the output shaft 130, noise may be generated between the gear teeth. As described above, the noise between the first shaft 310 and the second shaft 320 is reduced by the pressurizing member 330.

Hereinafter, a structure of reducing noise of the second shaft 320 and the output shaft 130 is described.

Referring to FIGS. 6 and 7, according to an embodiment, the steering actuator 100 according to the present embodiments may further include a first housing 141 coupled with the motor 110 to receive the reducer 120 and a second housing 142 coupled with the first housing 141 to receive the output shaft 130.

As described below in detail, it is possible to adjust the gap between the first gear portion 322 and the second gear portion 511 and reduce noise by adjusting the coupling angle between the first housing 141 and the second housing 142.

According to an embodiment, the first housing 141 may have a first communication hole 711 through which the second shaft 320 passes, the second shaft 320 may be provided so that the first gear portion 322 protrudes outward of the first housing 141. The second housing 142 may have a second communication hole 712 for receiving the second gear portion 511, and the first gear portion 322 may be engaged with the second gear portion 511 in the second communication hole 712.

In other words, the first communication hole 711 and the second communication hole 712, respectively, are provided in the first housing 141 and the second housing 142, and he first communication hole 711 is provided coaxially with the first shaft 310.

As described below in detail, as the first housing 141 and the second housing 142 are relatively rotated, the inter-axis distance between the second shaft 320 and the output shaft 130 may be adjusted, and the gap between the first gear portion 322 and the second gear portion 511 may be adjusted, and the noise may be reduced.

According to an embodiment, the first housing 141 may have a coupling portion 611 protruding in the axial direction of the second shaft 320 and having the first communication hole 711, and the second housing 142 may have a coupling hole 612 to which the coupling portion 611 is inserted.

As the first housing 141 and the second housing 142 are coupled, the coupling portion 611 is inserted into the coupling hole 612. The coupling hole 612 and the coupling portion 611 have a circular shape, and in a state in which the coupling portion 611 is inserted in the coupling hole 612, the first housing 141 and the second housing 142 may be relatively rotated about the central axis of the coupling portion 611 and the coupling hole 612.

According to an embodiment, the coupling portion 611 and the coupling hole 612 may be eccentric with respect to the first communication hole 711.

Referring to FIGS. 8 and 9, the coupling portion 611 and the coupling hole 612 may be coaxial, but eccentric to the first communication hole 711. Accordingly, as the first housing 141 and the second housing 142 are relatively rotated about the central axis of the coupling portion 611 and the coupling hole 612 in a state in which the first housing 141 and the second housing 142 are coupled, the inter-axis distance between the central axis of the coupling portion 611 and the coupling hole 612 and the central axis of the second shaft 320 and the first communication hole 711 is increased.

For example, the second housing 142 may be coupled and fixed to the vehicle body, and the first housing 141 may be rotated about the second housing 142 with respect to the central axis of the coupling portion 611 and the coupling hole 612.

By the relative rotation of the first housing 141 and the second housing 142, the inter-axis distance between the central axis of the coupling portion 611 and the coupling hole 612 and the central axis of the second shaft 320 and the first communication hole 711 is increased/decreased, so that the inter-axis distance between the second shaft 320 and the output shaft 130 fixed to the second housing 142 is also increased/decreased.

Therefore, the inter-gear tooth gap between the first gear portion 322 of the second shaft 320 and the second gear portion 511 of the output shaft 130 may be adjusted, reducing noise.

According to an embodiment, the first housing 141 may have at least one first coupling portion 151 having a long hole concentric with the coupling portion 611 and the coupling hole 612, and the second housing 142 may have at least one a second coupling portion 152 having a hole, and the first housing 141 and the second housing 142 may be coupled by a coupling member 153 coupled to the first coupling portion 151 and the second coupling portion 152.

In other words, to adjust the inter-gear tooth gap between the first gear portion 322 and the second gear portion 511, the first housing 141 and the second housing 142 may be relatively rotated, and the first housing 141 and the second housing 142 may then be fixed by the coupling member 153. The first coupling portion 151 formed in the first housing 141 has an arc-shaped long hole, and the long hole is formed to be concentric with the coupling portion 611 and the coupling hole 612.

According to an embodiment, the coupling member 153 may be a bolt. As the coupling member 153 is inserted into the long hole of the first coupling portion 151 and the hole of the second coupling portion 152, and a nut is coupled to the coupling member 153, the first housing 141 and the second housing 142 may be fixed to each other.

As the long hole of the first coupling portion 151 is formed concentrically with the coupling portion 611 and the coupling hole 612, the first housing 141 and the second housing 142 may be relatively rotated in a state in which the coupling member 153 is inserted in the long hole of the first coupling portion 151 and the hole of the second coupling portion 152.

In other words, after the gap between gear teeth is adjusted through relative rotation in a state in which the nut is loosely coupled to the coupling member 153, the nut may be tightened, simply fixing the first housing 141 and the second housing 142.

By the so-structured steering actuator 100 and the mobility vehicle, there may be provided a steering actuator having a compact structure and capable of enhancing the driver's sense of steering and a mobility vehicle including the same.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

1. A steering actuator, comprising:
a motor;
an output shaft connected to a knuckle arm; and
a reducer connecting the motor and the output shaft.

2. The steering actuator of claim 1, wherein the output shaft is coupled to a Pitman arm connected to the knuckle arm.

3. The steering actuator of claim 2, wherein at least one of the output shaft and the Pitman arm is serrated.

4. The steering actuator of claim 1, further comprising an electronic control unit controlling the motor.

5. The steering actuator of claim 1, further comprising a rotation angle sensor sensing a rotational angle of the output shaft.

6. The steering actuator of claim 1, wherein the reducer includes:
a first shaft coupled to a motor shaft of the motor; and
a second shaft having a reduction ratio and rotated by rotation of the first shaft.

7. The steering actuator of claim 6, wherein the first shaft is a worm shaft, and the second shaft has a worm wheel engaged with the worm shaft.

8. The steering actuator of claim 7, further comprising a pressurizing member pressurizing the first shaft in a direction of being engaged with the worm wheel.

9. The steering actuator of claim 6, wherein the second shaft has a first gear portion, and the output shaft has a second gear portion engaged with the first gear portion.

10. The steering actuator of claim 9, wherein a reduction ratio of the output shaft to the second shaft is smaller than 1.

11. The steering actuator of claim 9, wherein the first gear portion is a pinion gear, and the second gear portion is a sector gear.

12. The steering actuator of claim 9, further comprising:
a first housing coupled with the motor to receive the reducer; and
a second housing coupled with the first housing to receive the output shaft.

13. The steering actuator of claim 12, wherein the first housing has a first communication hole, and the second shaft passes through the first communication hole so that the first gear portion protrudes outward of the first housing, and wherein the second housing has a second communication hole receiving the first gear portion so that the first gear portion is engaged with the second gear portion in the second communication hole.

14. The steering actuator of claim 13, wherein the first housing has a coupling portion protruding in an axial direction of the second shaft and having the first communication hole formed therein, and wherein the second housing has a coupling hole to which the coupling portion is inserted.

15. The steering actuator of claim 14, wherein the coupling portion and the coupling hole are disposed eccentrically with respect to the first communication hole.

16. The steering actuator of claim 15, wherein the first housing has at least one first coupling portion formed as a long hole concentric with the coupling portion and the coupling hole, and the second housing has at least one second coupling portion with a hole, so that the first housing and the second housing are coupled to each other by a coupling member coupled with the first coupling portion and the second coupling portion.

17. The steering actuator of claim 16, wherein the coupling member is a bolt.

18. A mobility vehicle comprising the steering actuator of claim 1.

19. The mobility vehicle of claim 18, further comprising:
a steering angle sensor sensing a rotational angle of a steering shaft; and
an electronic control unit receiving rotational angle information about the steering shaft from the steering angle sensor and controlling the steering actuator.

20. The mobility vehicle of claim 18, wherein the steering actuator steers a front wheel.
